(19) United States
(12) Patent Application Publication
(10) Pub. No.: US 2024/0077871 A1
(43) Pub. Date: Mar. 7, 2024

(54) VIRTUAL REALITY DEVICE, SERVER, AND METHOD OF CONTROLLING DRONE SWARM BASED ON IMMERSIVE VIRTUAL REALITY

(71) Applicant: Electronics and Telecommunications Research Institute, Daejeon (KR)

(72) Inventors: Uihwan CHOI, Daejeon (KR); In Jun KIM, Daejeon (KR); Jeonggi YANG, Daejeon (KR); Soo Jeon LEE, Daejeon (KR)

(73) Assignee: Electronics and Telecommunications Research Institute, Daejeon (KR)

(21) Appl. No.: 18/089,219

(22) Filed: Dec. 27, 2022

(30) Foreign Application Priority Data
Sep. 1, 2022 (KR) 10-2022-0110554

(51) Int. Cl. G05D 1/00; B64U 10/00; G05D 1/10; G06F 3/01; G06F 3/0346; G06F 3/04815; G06F 3/04842; G06T 19/00

(52) U.S. Cl. CPC G05D 1/0044; B64U 10/00; G05D 1/0027; G05D 1/104; G06F 3/011; G06F 3/017; G06F 3/0346; G06F 3/04815; G06F 3/04842; G06T 19/00; B64U 2201/20; G06T 2200/24

(57) ABSTRACT

A drone swarm control method is provided. The drone swarm control method includes displaying a drone swarm and a three-dimensional (3D) terrain projected onto a virtual reality (VR) space by using a VR headset, based on user manipulation, selecting a small-scale drone swarm, provided in a region of interest (ROI) set in the 3D terrain, from the drone swarm by using a VR controller, based on the user manipulation, and dividing, by using a server, the ROI into a plurality of cells, respectively allocating the divided plurality of cells to drones included in the small-scale drone swarm, and automatically generating a 3D flight path of a drone allocated to each of the divided plurality of cells, based on user input information representing the small-scale drone swarm and the ROI.

### CROSS-REFERENCE TO RELATED APPLICATIONS

This application claims the benefit of the Korean Patent Application No. 10-2022-0110554 filed on Sep. 1, 2022, which is hereby incorporated by reference as if fully set forth herein.

### BACKGROUND

### Field of the Invention

The present invention relates to drone swarm control technology, and more particularly, to technology for controlling a drone swarm by using immersive virtual reality.

### Discussion of the Related Art

Recently, communication equipment and observation equipment having high performance are equipped in drones. Therefore, drones are being widely used in platforms for collecting various-purpose observation data with low cost and high efficiency.

Drones may observe a wide area, and thus, in a case where a plurality of drones are used, it is possible to observe a wider area. In this case, a wide area is divided into a plurality of areas, a plurality of drones are respectively allocated to the plurality of areas, and it is required to set a mission planning for setting a flight path of a drone allocated to each area.

An operation of setting a mission planning is performed by a control person through a conventional input interface such as a keyboard, a mouse, or a screen touch, and in this case, as the number of drones increases, a mission planning time based on the conventional input interface increases. Also, an operation of setting a mission planning through the conventional input interface is an operation which is high in level of difficulty even in terms of skilled users.

### SUMMARY

An aspect of the present invention is directed to providing a virtual reality device, a server, and a drone swarm control method, which may control a drone swarm through a combination of immersive virtual reality technology and technology for automatically setting a mission planning so as to considerably shorten a time taken in setting a mission planning of the drone swarm.

To achieve these and other advantages and in accordance with the purpose of the invention, as embodied and broadly described herein, there is provided a drone swarm control method including: displaying a drone swarm and a three-dimensional (3D) terrain projected onto a virtual reality (VR) space by using a VR headset, based on user manipulation; selecting a small-scale drone swarm, provided in a region of interest (ROI) set in the 3D terrain, from the drone swarm by using a VR controller, based on the user manipulation; and dividing, by using a server, the ROI into a plurality of cells, respectively allocating the divided plurality of cells to drones included in the small-scale drone swarm, and automatically generating a 3D flight path of a drone allocated to each of the divided plurality of cells, based on user input information representing the small-scale drone swarm and the ROI.

In another aspect of the present invention, there is provided a virtual reality (VR) device including: a VR headset configured to display a drone swarm and a three-dimensional (3D) terrain projected onto a VR space, based on user manipulation; and a VR controller configured to set a region of interest (ROI) in the 3D terrain and select a small-scale drone swarm, provided in the set ROI, from the drone swarm, based on the user manipulation. Here, the VR controller may generate user input information including the set ROI and the selected small-scale drone swarm and may transmit the user input information to a server which automatically generates a mission planning of the small-scale drone swarm.

In an embodiment, the VR headset may include: a communication interface configured to receive VR information from the server; a processor configured to process the VR information; and a display unit configured to display a VR space included in the VR information and the 3D terrain and the drone swarm projected onto the VR space, based on control by the processor.

In an embodiment, the display unit may display a line surrounding the ROI set by the VR controller and the drones included in the small-scale drone swarm provided in the ROI by using outlines having different specific fluorescent colors.

In an embodiment, the VR controller may include: a sensor configured to sense a motion of the VR controller; a processor configured to set an ROI in the 3D terrain by using a virtual guideline and a virtual pointer which move in the VR space, based on the motion of the VR controller, select a small-scale drone swarm provided in the set ROI, and generate user input information including the set ROI and the selected small-scale drone swarm; and a communication interface configured to transmit the user input information to the server.

In another aspect of the present invention, there is provided a server including: a first communication interface configured to receive a region of interest (ROI), set in a three-dimensional (3D) terrain projected onto a virtual reality (VR) space by a VR device, and user input information including a small-scale drone swarm provided in the ROI and a mission altitude of each of drones included in the small-scale drone swarm; a processor configured to divide the ROI into a plurality of cells, respectively allocate the divided plurality of cells to the drones included in the small-scale drone swarm, and automatically calculate a 3D flight path including the mission altitude and a coverage path of a corresponding drone allocated to each of the divided plurality of cells; and a second communication interface configured to transmit mission planning information including the 3D flight path to the drones included in the small-scale drone swarm.

In an embodiment, the processor may perform an operation of dividing the ROI into a number of cells equal to the number of drones included in the small-scale drone swarm.

In an embodiment, the processor may perform an operation of respectively allocating the divided cells to the drones included in the small-scale drone swarm by using a mission assignment algorithm.

In an embodiment, the processor may automatically calculate a 3D flight path of a corresponding drone allocated to each cell by using a path planning algorithm.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a block diagram of a drone swarm control system based on immersive virtual reality (VR) according to an embodiment of the present invention.

FIG. 2 is a diagram for describing VR information displayed through a display device of a VR headset according to an embodiment of the present invention.

FIG. 3 is a diagram for describing a process of setting a region of interest (ROI) by using a VR controller and a process of determining a small-scale drone swarm where a specific mission is to be assigned to the set ROI in a drone swarm, according to an embodiment of the present invention.

FIG. 4 is a block diagram of a server according to an embodiment of the present invention.

FIG. 5 is a diagram for describing a region division process performed by a region division module according to an embodiment of the present invention.

FIG. 6 is a diagram for describing a coverage path generating process performed by a path generating module according to an embodiment of the present invention.

FIG. 7 is a diagram for describing a three-dimensional (3D) flight path generated by the path generating module according to an embodiment of the present invention.

FIG. 8 is a block diagram of a VR headset and a VR controller according to an embodiment of the present invention.

FIGS. 9A and 9B are diagrams for describing a simulation result of a swarm mission planning according to an embodiment of the present invention.

FIG. 10 is a flowchart for describing a method of controlling a drone swarm on the basis of immersive VR, according to an embodiment of the present invention.

### DETAILED DESCRIPTION OF THE INVENTION

A drone may observe a wide region, and in a case where a plurality of drones are used, it may be possible to observe a wider region. Hereinafter, a plurality of drones used to observe a wider region may be referred to as a drone swarm.

A drone swarm configured with a plurality of drones (for example, ten or more drones) may be quickly and effectively controlled, and an operation of setting a mission planning and a flight path suitable for each drone may be an operation which is high in level of difficulty even in terms of skilled control personnel.

Particularly, in a case where a drone swarm is used in a disaster situation or a war situation requiring the quick collection of information, a change (for example, facilities modification, the spread of forest fire, and the diffusion of river green/red) in a mission environment to be mapped to a drone swarm may frequently occur, and a drone operating aim (for example, an observation region interested by a control person at a current time may be frequently changed.

In such a dynamic mission environment, technology which quickly changes (re-plans) a prior mission planning, uploaded to each drone before a drone takes off, in performing a mission may be needed. However, in a scenario using a drone swarm, a control load of a control person (operator) for a mission re-planning may rapidly increase. This may be because most drone control software (for example, QGroundControl, UGCS, etc.) used for controlling a current drone swarm are driven in a personal computer (PC), a mobile terminal, or a tablet PC which provides a conventional input interface such as a keyboard, a mouse, or a screen touch, and due to this, the real-time reactivity of a user is reduced.

A user may recognize drone information displayed by corresponding drone control software by using a two-dimensional (2D) monitor or display screen and may input a drone mission command, desired by the user, to the drone control software through a conventional input interface. In such a process, the following three types of time delays may occur.
(A) Swarm situation recognition: a time taken in accurately recognizing, by a user, a mission situation and a current state of a drone swarm through a 2D monitor or a display screen
(B) User decision: a time needed for determining and designing, by a user, a mission planning (a mission planning of a drone swarm) suitable for a situation change.
(C) Swarm command assignment: a time for inputting, by a user, a drone-based detailed mission planning to control software (SW) through a keyboard, a mouse, or a screen touch

Conventional drone control software may have a fundamental limitation in shortening a time taken in (A), (B), and (C). Furthermore, in a case where ten or more drone swarms are used, a time taken in each step may exponentially increase.

Therefore, the present invention may provide a system and method of controlling a drone swarm, based on a combination of mission planning automatic setting technology and immersive virtual reality (VR) technology for considerably reducing a time (i.e., a time taken in setting a mission planning of a drone swarm) taken in each of (A), (B), and (C) in a scenario using a drone swarm.

In more detail, the present invention may propose interface technology for controlling a drone swarm by using an immersive VR device, technology which monitors a drone swarm by using an immersive VR headset, technology which intuitively defines mapping mission information about a drone swarm by using a VR controller, and swarm mission planning technology which automatizes a mapping mission for a wide region by using a drone swarm.

Accordingly, the present invention may provide an effect for considerably shortening a time taken in all of “swarm situation recognition”, “user decision”, and “swarm command assignment” and reducing an operation load of a control person.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components. The present application, it should be understood that the term “connect” denotes a physical connection between elements described in the present specification and moreover includes an electrical connection and a network connection.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

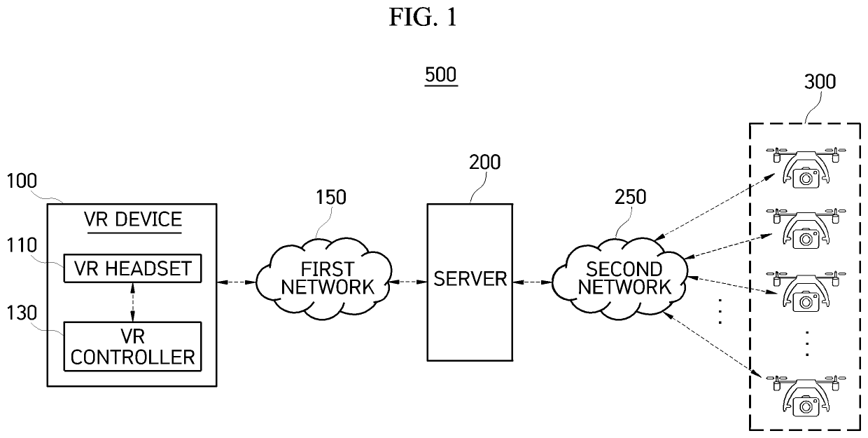

FIG. 1 is a block diagram of a drone swarm control system 500 based on immersive VR according to an embodiment of the present invention.

Referring to FIG. 1, the drone swarm control system 500 based on immersive VR according to an embodiment of the present invention may include a VR device 100, a server 200, and a drone swarm 300 and may further include first and second networks 150 and 250 which support a communication connection between the elements 100, 200, and 300.

The VR device 100 and the server 200 may exchange a command, data, or information over the first network 150, based on a wired or wireless communication scheme. Here, the first network 150 may include, for example, Wi-Fi direct, Bluetooth, Internet, or a computer network such as local area network (LAN), or wide area network (WAN).

The server 200 and the drone swarm 300 may exchange a command, data, or information over the second network 250, based on wireless communication. The wireless communication may include, for example, cellular communication using at least one of long term evolution (LTE), LTE advance (LTE-A), 5G, code division multiple access (CDMA), wideband CDMA (WCDMA), universal mobile telecommunications system (UMTS), wireless broadband (WiBro), and global system for mobile communications (GSM). Accordingly, the second network 250 may be a network for supporting the wireless communication or an independent network which includes ad-hoc and a mobile base station.

Herein, the first network 150 and the second network 250 may be differentiated from each other, but are not limited thereto and may be described as one network. In this case, the wireless communication may include, for example, cellular communication using at least one of LTE, LTE-A, 5G, CDMA, WCDMA, UMTS, WiBro, and GSM.

According to an embodiment, the wireless communication may include, for example, at least one of wireless fidelity (Wi-Fi), Bluetooth, Bluetooth low energy (BLE), Zigbee, near field communication (NFC), magnetic secure transmission, radio frequency (RF), and body area network (BAN).

According to an embodiment, the wireless communication may be GNSS. GNSS may be, for example, global positioning system (GPS), global navigation satellite system (GNSS), Beidou navigation satellite system (hereinafter referred to as “Beidou”), Galileo, or the European global satellite-based navigation system. Herein, GPS may be used to be compatible with GNSS.

Wired communication described herein may include at least one of universal serial bus (USB), high definition multimedia interface (HDMI), recommended standard232 (RS-232), low energy communication, and plain old telephone service (POTS).

The VR device 100 may be a device for supporting an immersive user experience (UX) and may fundamentally include a VR headset 110 and a VR controller (or a VR motion controller) 130.

The VR headset 110 may be a type of wearable device mounted on a head of a user and may be a head mounted display (HMD) device.

The VR headset 110 may execute or reproduce VR content received from the server 200 over the first network 150 to output a two-dimensional (2D) or three-dimensional (3D) VR space. Herein, the VR headset 110 may execute or reproduce the VR content to output a 3D VR space, but is not limited thereto and may execute or reproduce augmented reality (AR) content, mixed reality (MR) content, extended reality (ER) content, or substitutional reality (SR) content to output an AR space, an MR space, an ER space, or an SR space.

The VR space may be displayed by a display device included in the VR headset 110, and a user may recognize the VR space displayed by the display device in a state where the VR headset is mounted on a head.

Moreover, a user may input various commands (for example, a drone swarm command) to a VR space and/or a virtual object (for example, a drone swarm) projected onto the VR space, and a means enabling the input may be the VR controller 130.

The VR controller 130 may be a device which is used to input various commands to a VR space, and a user may input the various commands to the VR space with an arm motion and/or a hand motion such as a motion, a gesture, or a grip with gripping the VR controller 130.

To recognize an arm motion and/or a hand motion of a user, the VR controller 130 may be configured to include a plurality of motion recognition sensors. Also, the VR controller 130 may further include an analog input means such as a joystick, a joystick thumb stick, a trackpad, or a button, and various input schemes may be implemented by a combination of a sensing result of a motion recognition sensor and the analog input means.

The VR controller 130 may be paired with the VR headset 110, based on a wireless communication scheme (a close-distance wireless communication scheme). When the VR controller 130 is paired with the VR headset 110, the VR headset 110 may receive motion information of the VR controller 130, which is based on an arm motion and/or a hand motion of a user, from the VR controller 130.

The VR headset 110 may display a pointer, indicated by the VR controller 130, on a VR space displayed by a display device embedded in the VR headset 110 on the basis of the motion information about the VR controller 130, and the pointer may freely move in the VR space on the basis of the motion information of the VR controller 130.

The user may set a mission planning of the drone swarm 300 projected onto the VR space through a manipulation of moving the pointer. The mission planning which is set by the user by using the VR headset 110 and/or the VR controller 130 may be transmitted to the server 200 over the first network 150. Hereinafter, the mission planning which is set by the user by using the VR headset 110 and/or the VR controller 130 may be referred to as “user input information”.

Such user input information may include various information for setting a mission planning of the drone swarm 300. For example, the user input information may include “drone information” and “mission information”.

The drone information may include number information about drones included in a small-scale drone swarm selected from among drones (drone swarms) provided in a region of interest (ROI) which is set by the user in a VR space by using the VR controller 130, a takeoff/landing altitude of each of the drones, a horizontal moving speed of each of the drones, an ascending and descending speed of each of the drones, and takeoff/landing position information about the drones.

The mission information may include position information representing the ROI and a mission altitude, a horizontal moving speed, and a photographing interval of each of drones projected onto the ROI.

Information associated with a speed, a time, and an altitude among the mission information and the drone information may be set by the user through a setting item of a virtual menu window projected onto a VR space by using the VR controller 130.

The server 200 may receive the user input information including the mission information and the drone information from the VR device 100 (the VR headset 110 or the VR controller 130) over the first network 150. Also, the server 200 may automatically set a mission planning of the drone swarm 300 or a small-scale drone swarm selected from the drone swarm 300, based the received user input information. A mission planning automatic setting process performed by the server 200 will be described below in detail.

The drone swarm 300 may include a plurality of drones (drone objects). The number of drones configuring the drone swarm 300 may be 10 to 100 or more.

A mobile base station or a commercial network, such as an LTE network or a 5G network, or an available communication network implemented as an independent network such as an ad-hoc network may be constructed in a drone operating region.

Each drone may be equipped with a communication module such as an LTE modem or a 5G modem and may communicate with the server 200 over the constructed available communication network. Also, each drone may be equipped with sensing mission equipment (a camera, etc.), a mission computer (MC), and/or a flight controller computer (FC).

Each drone may transmit its own flight state information as a telemetry (TM) stream to the server 200 by using the communication module on the basis of a commercial protocol (for example, a Mavlink protocol) for drone control and may receive a telecommand (TC), defining flight control and a mission planning, from the server 200.

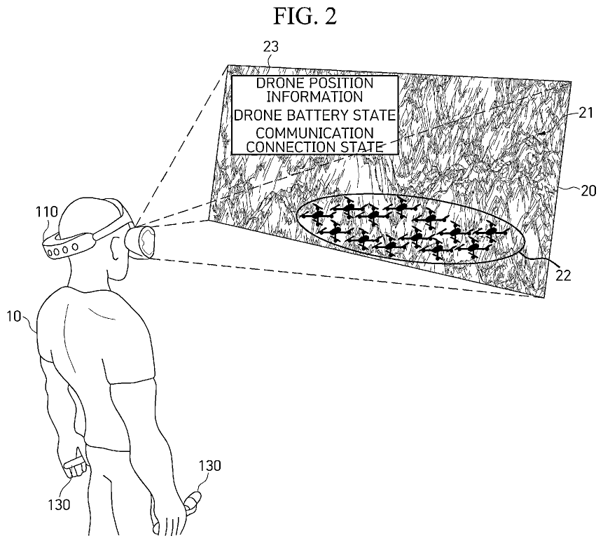

FIG. 2 is a diagram for describing VR information displayed through a display device of a VR headset according to an embodiment of the present invention.

Referring to FIG. 2, a user 10 may recognize immersive 3D VR information (or a 3D VR space) through a display screen of the VR headset 110 in a state where the VR headset 110 is worn on a head.

The VR information may be information projected onto a virtual plane 20 and may include a virtual 3D terrain object 21, a virtual 3D facility object, a virtual drone swarm object 22, and drone state information 23.

In FIG. 2, the virtual 3D terrain object 21 representing a mountainous terrain is illustrated for example.

The virtual drone swarm object 22 may include a plurality of virtual drone objects, and in FIG. 2, the virtual drone swarm object 22 including 13 virtual drone objects is illustrated for example.

The drone state information 23 may be projected onto the virtual plane 20 in the form of texts or digits. The drone state information 23 may include, for example, position information representing a position, a longitude, and an altitude of each drone, battery state information about each drone, and a communication connection state of each drone. The battery state information may be information representing a battery charging state. The drone state information may be projected onto a periphery of a virtual drone object.

A photograph image or video obtained by the actual photographing of each drone may be further projected onto an arbitrary region of the virtual plane 20.

The user may recognize 3D VR information having various observer viewpoints by using the display device of the VR headset 110. The observer viewpoint may include, for example, a viewpoint when the virtual drone swarm object 22 is seen from above, a viewpoint when the virtual drone swarm object 22 is seen from below, a viewpoint when a main mission point/main facility is seen intensively, and a viewpoint when an individual virtual drone is seen at a close position.

The changing of an observer viewpoint may be performed through, for example, a motion of the VR headset 110 based on a head motion of a user and a manipulation of a physical input means (for example, a button, a joystick, a trackpad, etc.) of the VR controller 130.

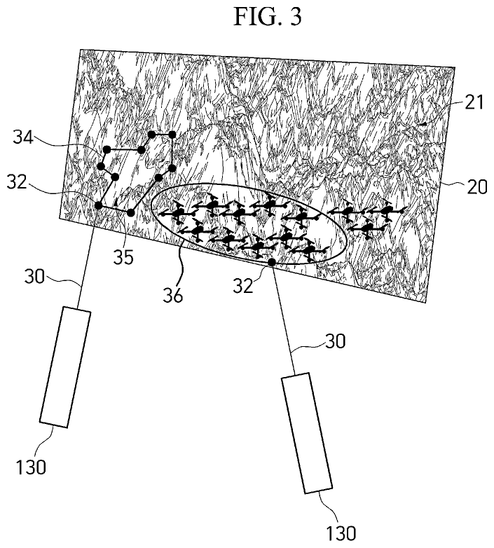

FIG. 3 is a diagram for describing a process of setting an ROI by using a VR controller and a process of determining a small-scale drone swarm where a specific mission is to be assigned to the set ROI in a drone swarm, according to an embodiment of the present invention.

Referring to FIG. 3, an ROI 35 for performing specific missions such as reconnaissance, exploration, and observation may be set by a virtual guideline 30 generated by the VR controller 130 and a virtual pointer 32 representing an end of the virtual guideline 30.

The virtual guideline 30 may be displayed on a VR space in a direction in which the VR controller 130 faces. The virtual pointer 32 may be displayed on a virtual plane on which an end of the virtual guideline 30 is disposed.

A user may set an ROI 35 having a polygonal shape on the virtual plane 20 through a drag motion and a gesture which draws a line 34, surrounding the ROI 35, on the virtual plane 20, by using the virtual pointer 32 and the virtual guideline 30 generated in a VR space by the VR controller 130. The line 34 surrounding the set ROI 35 may be displayed by an outline having a specific fluorescent color.

Moreover, the user may set specific mission points on the virtual plane 20 instead of a region, by using the virtual guideline 30 and the virtual pointer 32. In this case, the set specific mission points may be displayed in a specific fluorescent color.

When the setting of the ROI 35 having a polygonal shape is completed, a process of selecting a small-scale drone swarm to which a specific mission for the set ROI is to be assigned, and the small-scale drone swarm may be selected by using the virtual guideline 30 and the virtual pointer 32 generated by the VR controller 130.

The user may select a small-scale drone swarm through a drag motion and a gesture which draws a line 36 surrounding drones, to which missions are to be assigned, of all drones included in a drone swarm by using the virtual guideline 30 and the virtual pointer 32. In FIG. 3, an example which selects a small-scale drone swarm including 10 drones of 13 drones is illustrated.

The selected small-scale drone swarm may be displayed by an outline having a specific fluorescent color which differs from a specific fluorescent color of the line 34 surrounding the set ROI 35. Herein, an example which selects a small-scale drone swarm may be described, but one drone may be selected. The selected small-scale drone swarm and an unselected small-scale drone swarm may be displayed in different fluorescent colors.

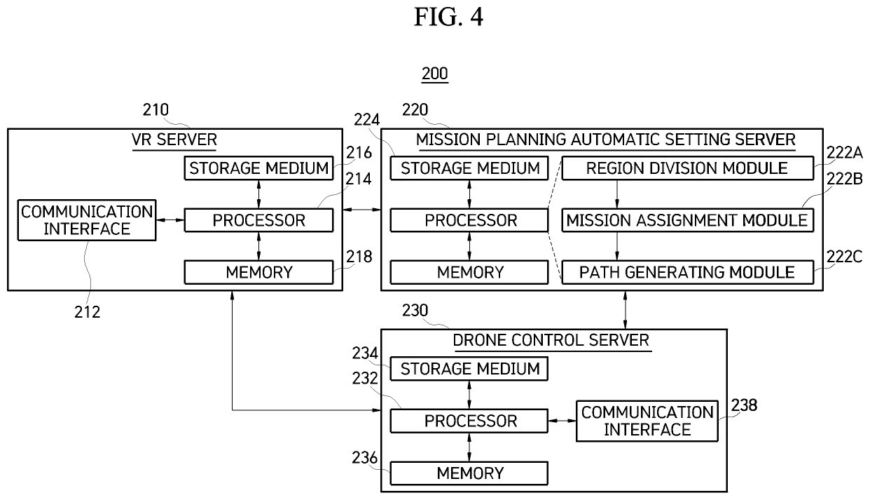

FIG. 4 is a block diagram of a server 200 according to an embodiment of the present invention.

Referring to FIG. 4, the server 200 may be a medium device which connects the VR device 100 with the drone swarm 300. The server 200 may implement VR displayed by the VR device 100 and may automatically set a mission planning of a drone swarm, an individual drone included in the drone swarm, or a small-scale drone swarm selected from the drone swarm, based on user input information (drone information and mission information) received from the VR device 100.

The server 200 should perform a real-time graphics operation and information processing for implementing VR (a VR space), and thus, may be configured with server devices including a high-spec processor and a memory.

To this end, the server 200 may include a VR server 210, a mission planning automatic setting server 220, and a drone control server 230. Herein, three servers may be described for example, but the present invention is not limited thereto. For example, one of three servers 210, 220, and 230 may be integrated into one of two other servers, or the three servers 210, 220, and 230 may be integrated into one server.

The VR server 210 may fundamentally include a communication interface 212, a processor 214, a storage medium 216, and a memory 218.

The communication interface 212 may communicate with the VR device 100 over a first network (150 of FIG. 1) by wire or wirelessly. The communication interface 212 may be configured with known hardware elements for supporting wired or wireless communication.

The processor 214 may be a hardware element which controls and manages operations of peripheral elements 212, 216, and 218 and may perform a real-time graphics operation and information processing for implementing a VR space. To this end, the processor 214 may be configured by at least one central processing unit (CPU), at least one graphics processing unit (GPU), at least one micro controller unit (MCU), or a combination thereof.

The storage medium 216 may be a non-volatile storage medium. The storage medium 216 may store a VR dedicated program which is constructed through a VR (AR, MR, ER, or SR) development engine such as unity or an unreal engine. Also, the storage medium 216 may further store a flight log of a drone and drone data such as a video and an image obtained through photographing by a drone.

The memory 218 may be a hardware element which includes a volatile memory and/or a non-volatile memory and may temporarily store data and a command associated with the VR dedicated program. The VR dedicated program stored in the storage medium 216 may be executed by loading a relevant command and data into the memory 218, based on control by the processor 214.

The VR dedicated program may render 3D VR information (or a 3D VR space) on the basis of control by the processor 214, and the rendered 3D VR information may be transmitted to the VR headset 110 of the VR device 100 through the communication interface 212 and the first network 150 in real time.

The VR headset 110 may display the rendered 3D VR information, received from the VR server 210, on a display screen, and thus, a user worn with the VR headset 110 may recognize a 3D VR space corresponding to the rendered 3D VR information.

The processor 214 may project data (a current drone position, etc.), needed for rendering, onto a 3D VR space on the basis of immersive interaction data (a headset angle, a controller position, an angle, a button input, etc.) received from the VR device 100 through the first network 150 and the communication interface 212 and drone data such as a flight log, an image, and a video input from the storage medium 216.

Moreover, the processor 214 may transfer user input information (drone information and mission information), received from the VR device 100 through the first network 150 and the communication interface 212, to the mission planning automatic setting server 220. In this case, the user input information may be directly transferred to the mission planning automatic setting server 220 without passing through the VR server 210, and in this case, the mission planning automatic setting server 220 may include a communication interface for directly communicating with the VR device 100.

The mission planning automatic setting server 220 may automatically set a mission planning of a drone swarm or a small-scale drone swarm selected from the drone swarm, based on the user input information (the drone information and the mission information) transferred through the VR server 210. To this end, the mission planning automatic setting server 220 may include a processor 222, a storage medium 224, and a memory 226, and in a case where the mission planning automatic setting server 220 directly receives the user input information (the drone information and the mission information) from the VR device 100, although not shown in FIG. 4, the mission planning automatic setting server 220 may further include a communication interface.

The processor 222 may be a hardware element which controls and manages operations of peripheral elements 224 and 226 and may perform a real-time graphics operation and information processing for automatically setting a mission planning of a drone swarm or a small-scale drone swarm selected from the drone swarm. To this end, the processor 222 may be configured by at least one CPU, at least one GPU, at least one MCU, or a combination thereof.

The storage medium 224 may be a non-volatile storage medium and may store a software module which is executed and controlled by the processor 222 so as to automatically set a mission planning of a drone swarm or a small-scale drone swarm selected from the drone swarm. Here, the software module may include a region division module 222A, a mission assignment module 222B, and a path generating module 222C. Also, the storage medium 224 may further store current position information, a mission speed, and altitude information for each drone.

The memory 226 may be a hardware element which includes a volatile memory and/or a non-volatile memory and may provide an execution space of each of the software modules 222A, 222B, and 222C stored in the storage medium 224. The software modules 222A, 222B, and 222C stored in the storage medium 224 may be loaded into the memory 218 and executed based on control by the processor 222.

The region division module 222A executed by the processor 222 may divide an ROI (35 of FIG. 3), set by the user, into a plurality of cells on the basis of user input information received from the VR device 100 (110 and 130). In this case, the user input information may include information representing a polygonal ROI (35 of FIG. 3) (hereinafter referred to as ROI information) and number information about drones included in a small-scale drone swarm selected by the user. The ROI information may include coordinate information about a virtual line (34 of FIG. 3) surrounding the ROI (35 of FIG. 3) or coordinate information (virtual pixel coordinates) about points configuring the virtual line (34 of FIG. 3).

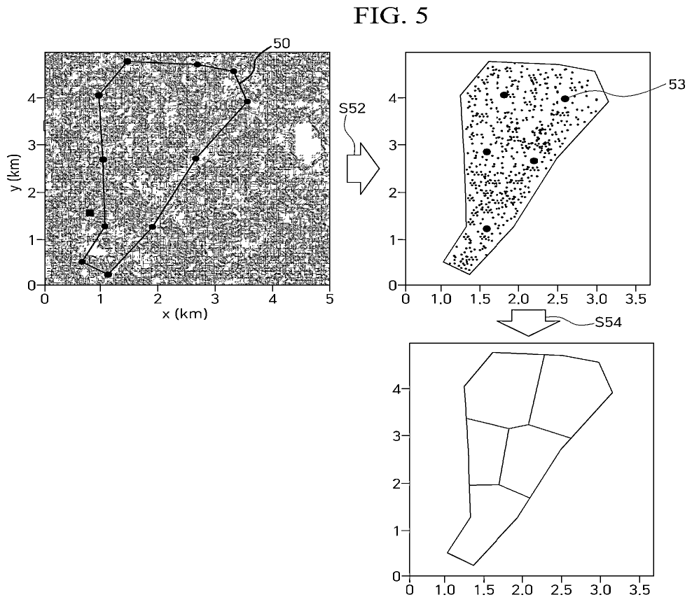

The region division module 222A may divide the polygonal ROI (35 of FIG. 3) into a number of cells equal to the number of drones included in the small-scale drone swarm. In order to divide the polygonal ROI (35 of FIG. 3) in real time, a region division algorithm such as a centroidal Voronoi tessellation technique may be used. Hereinafter, a region division process based on the technique will be described in detail with reference to FIG. 5.

FIG. 5 is a diagram for describing a region division process performed by a region division module according to an embodiment of the present invention.

Referring to FIG. 5, in step S52, a sufficient number of random sampling points (for example, 1,000 or more) may be generated in a polygonal ROI 50, and then, a process of clustering the points into a number of clusters equal to the number of drones included in the selected small-scale drone swarm by using a k-means algorithm may be performed.

Subsequently, in step S54, the polygonal ROI 50 may be divided into a number of cells equal to the number of drones included in the selected small-scale drone swarm by using a Voronoi partition scheme, with respect to a cluster-based centroid 53.

In FIG. 5, when the number of drones included in the selected small-scale drone swarm is five, an example which divides the polygonal ROI 50 into five cells is illustrated.

Referring again to FIG. 4, the mission assignment module 222B may perform an operation of allocating each of cells, obtained through division by the region division module 222A, to a corresponding drone included in the selected small-scale drone swarm. A known mission assignment algorithm may be used for solving a mathematic problem of allocating M number of missions (divided M number of cells) to N number of agents (N number of drones). Examples of the mission assignment algorithm may include a linear sum assignment algorithm, a sequential greedy assignment algorithm, and a Hungarian algorithm.

The path generating module 222C may perform an operation of generating (planning) a coverage path capable of sufficiently covering a total area of a cell to which each drone is allocated. The coverage path may be, for example, a path which is formed in zigzag in a cell.

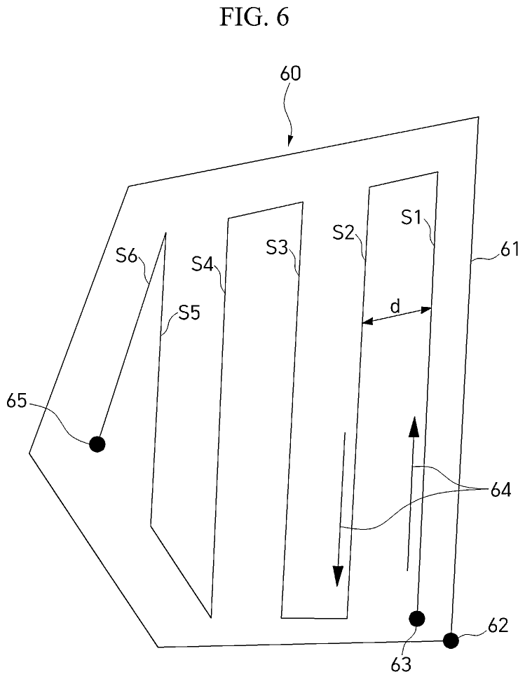

FIG. 6 is a diagram for describing a coverage path generating process performed by a path generating module according to an embodiment of the present invention.

Referring to FIG. 6, when it is assumed that a user sets a pentagonal ROI 60 by using the VR device 100, the path generating module 222C may select an arbitrary line segment 61 from among line segments configuring a pentagonal shape first, and an operation of detecting a start point 63 closest to a vertex 62 of the selected arbitrary line segment 61. Here, the arbitrary line segment may be a longest line segment or a shortest line segment. Herein, it may be assumed that a longest line segment is an arbitrary line segment.

Subsequently, the path generating module 222C may perform an operation of detecting a scan direction parallel to the longest line segment 61.

Subsequently, the path generating module 222C may calculate waypoints and the number of stripes S1 to S6 formed in the scan direction and continuous waypoints and a distance d between adjacent stripes S1 to S6. Finally, the path generating module 222C may designate the start point 63 and an end point 65 of a last stripe S6 to generate a coverage path.

A coverage path generating method may use various coverage path planning algorithms, based on a geometrical complexity of a cell, and for example, a back-and-forth coverage path planning algorithm or an autonomous driving algorithm used in vehicles or robots may be used.

Moreover, in order to prevent a collision between drones moving to each cell, the path generating module 222C may reflect a drone-based mission altitude and/or a drone-based takeoff/landing altitude, included in the user input information, in the coverage path to finally determine a drone-based 3D flight path.

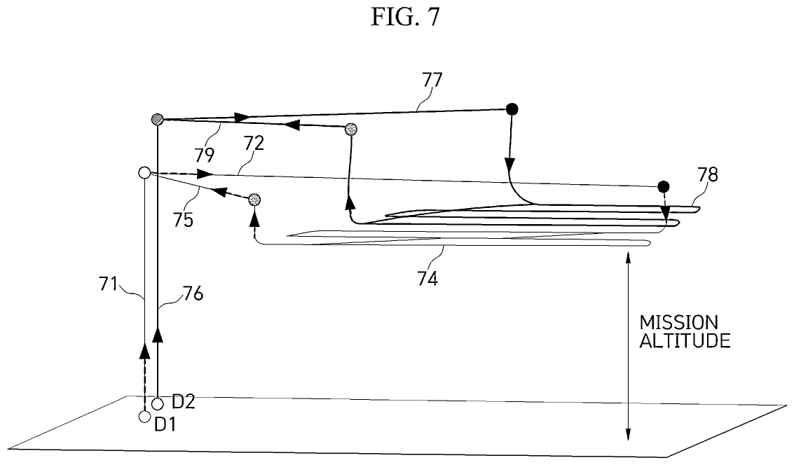

FIG. 7 is a diagram for describing a 3D flight path generated by the path generating module 222C according to an embodiment of the present invention.

In FIG. 7, a 3D flight path for two drones (for example, first and second flight paths) UAV1 and VAV2 is illustrated. A 3D flight path of the first drone UAV1 generated by the path generating module 222C may include a first takeoff/landing altitude 71, a first input path 72 based on the first takeoff/landing altitude 71, a mission altitude 73, a first coverage path 74 based on the mission altitude 73, and a first return path 75 based on the first takeoff/landing altitude 71.

The 3D flight path of the second drone VAV2 may include a second takeoff/landing altitude 76 which is higher than the first takeoff/landing altitude 71, a second input path 76 based on the second takeoff/landing altitude 76, the mission altitude 73, a second coverage path 78 based on the mission altitude 73, and a second return path 79 based on the second takeoff/landing altitude 76.

In FIG. 7, an example where mission altitudes of the two drones UAV1 and VAV2 are the same is illustrated, but the present invention is not limited thereto and the mission altitudes of the two drones UAV1 and VAV2 may differ.

Referring again to FIG. 4, the drone control server 230 may perform control on all drones of a drone swarm over a second network (250 of FIG. 1) and may store all data packets (telemetry, a capture image, and a capture video) received from the drones.

The drone control server 230 may receive drone state information in a telemetry (TM) form on the basis of a drone control protocol (for example, a Mavlink protocol). The drone control server 230 may convert flight control information, which is based on a mission planning (for example, a 3D flight path) transferred from the mission planning automatic setting server 220, into a telecommand (TC) defined in the drone control protocol (for example, the Mavlink protocol) and may transmit the telecommand to each of the drones.

The drone control server 230 may include a processor 232, a storage medium 234, a memory 236, and a communication interface 238.

The processor 232 may be a hardware element which controls and manages operations of peripheral elements 234, 236, and 238. The processor 232 may load a drone control program, stored in the storage medium 234, into the memory 236 to execute the drone control program and may process intermediate data and resultant data generated by the executed program.

Moreover, the processor 232 may process all data packets (telemetry, a flight log (a position, an angle, a battery state, etc.), a capture image, a capture video, etc.) received from a drone and may store the processed data packets in the storage medium 234, or may transfer the stored data packet to the VR server 210. The VR server 210 may generate VR information from information obtained through processing by the processor 232 so that a user recognizes the information and may transmit the VR information to the VR device 100.

The processor 232 may be configured by at least one CPU, at least one GPU, at least one MCU, or a combination thereof. The storage medium 234 may be a non-volatile storage medium, and the memory 236 may include a volatile memory and a non-volatile memory. The communication interface 238 may perform wireless communication, which is based on a drone control protocol (Mavlink, etc.), with a drone swarm.

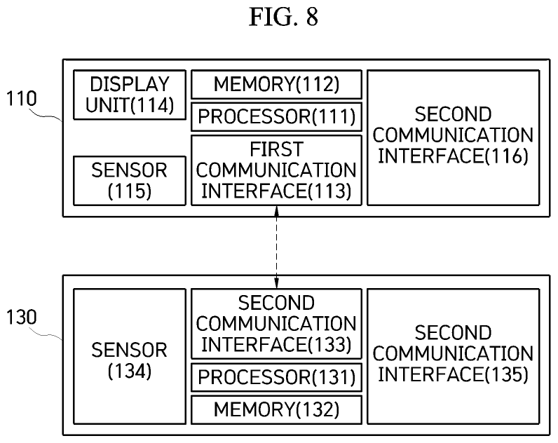

FIG. 8 is a block diagram of a VR headset 110 and a VR controller 130 according to an embodiment of the present invention.

Referring to FIG. 8, the VR headset 110 may include a processor 111, a memory 112, a first communication interface 113, a display unit 114, at least one sensor 115 for sensing a motion of the VR headset 110, and a second communication interface 116.

The processor 111 may control and manage operations of the memory 112, the first communication interface 113, the display unit 114, the at least one sensor 115, and the second communication interface 116 and may perform various data processing and operations.

The processor 111 may be implemented with, for example, a system on chip (SoC). The processor 111 may further include at least one CPU and/or at least one GPU. The processor 111 may load a command or data, received from at least one of the other elements (for example, a non-volatile memory), into a volatile memory and may store resultant data in a non-volatile memory.

The memory 112 may be a hardware element which provides an execution space for storing and executing a command and a program for processing VR information received from the server 200 through the second communication interface 116 and may include an internal memory or an external memory. The internal memory may include, for example, at least one of a volatile memory (for example, dynamic random access memory (DRAM), static random access memory (SRAM), or synchronous dynamic random access memory (SDRAM)) and a non-volatile memory (for example, one time programmable read only memory (OTPROM), programmable read only memory (PROM), erasable programmable read only memory (EPROM), electrical erasable programmable read only memory (EEPROM), mask read only memory (ROM), flash ROM, flash memory, hard drive, or solid state drive (SSD)). The external memory may include flash drive (for example, compact flash (CF), secure digital (SD), Micro-SD, Mini-SD, extreme digital (xD), multi-media card (MMC), or memory stick). The external memory may be physically connected to the VR headset 110 through various interfaces.

The first communication interface 113 may communicate with the VR controller 130 on the basis of close-distance wireless communication such as Bluetooth or Wi-Fi so as to exchange various information with the VR controller 130. The first communication interface 113 may include a Wi-Fi module, a Bluetooth module, and/or the like.

The display unit 114 may display 3D terrain information, projected onto a VR space based on VR information received from the server 200 through the second communication interface 116, and a drone swarm (for example, a virtual drone swarm) overlapping the 3D terrain information, based on control by the processor 111. Also, the display unit 114 may display a drone swarm and 3D terrain information converted into various viewpoints by the processor 111.

The sensor 115 may sense a motion of the VR headset 110 and a viewpoint at which the VR headset 110 sees and may convert measured or sensed information into an electrical signal. The sensor 115 may include, for example, a gesture sensor, a gyro sensor, an acceleration sensor, and an eyeball tracking sensor.

The second communication interface 116 may communicate with the server 200 over the first network 150 to exchange various information. The second communication interface 116 may include, for example, a cellular module, a Wi-Fi module, a Bluetooth module, a GNSS module, an NFC module, and an RF module. At least some (for example, two or more) of the cellular module, the Wi-Fi module, the Bluetooth module, the GNSS module, and the NFC module may be included in one integrated chip (IC) or an IC package. The RF module may transmit or receive, for example, a communication signal (for example, an RF signal). The RF module may include, for example, a transceiver, a power amplification module (PAM), a frequency filter, a low noise amplifier (LNA), or an antenna.

The VR controller 130 may include a processor 131, a memory 132, a first communication interface 133, a sensor 134 for sensing a motion of the VR controller 130, and a second communication interface 135.

The processor 131 may control and manage operations of the memory 132, the first communication interface 133, the sensor 134 for sensing a motion of the VR controller 130, and the second communication interface 135 and may perform various data processing and operations. The processor 131 may be implemented with, for example, an SoC. The processor 131 may further include at least one CPU and/or at least one GPU.

Based on a motion of the VR controller 130, the processor 131 may generate user input information which includes ROI information set in a 3D terrain projected onto a VR space, information (for example, number information about drones included in a small-scale drone swarm) about the small-scale drone swarm projected onto the ROI, and other information (for example, a mission altitude of each of the drones included in the small-scale drone swarm) and may transmit the user input information to the server 200 through the second communication interface 135.

The memory 132 may be a hardware element which provides an execution space for storing and executing a command and a program for processing VR information displayed by the VR headset 110 and may include an internal memory or an external memory.

The first communication interface 133 may communicate with the first communication interface 113 of the VR headset 113 by wire or wirelessly. The first communication interface 133 may be paired with the first communication interface 113 by wire or wirelessly.

The sensor 134 may sense a motion of the VR controller 130 and a direction indicated by the VR controller 130 and may convert measured or sensed information into an electrical signal. The sensor 134 may include, for example, a gesture sensor, a gyro sensor, and an acceleration sensor.

The second communication interface 135 may communicate with the server 200 over the first network 150 to exchange various information. The second communication interface 135 may include, for example, a cellular module, a Wi-Fi module, a Bluetooth module, a GNSS module, an NFC module, and an RF module. At least some (for example, two or more) of the cellular module, the Wi-Fi module, the Bluetooth module, the GNSS module, and the NFC module may be included in one IC or an IC package. The RF module may transmit or receive, for example, a communication signal (for example, an RF signal). The RF module may include, for example, a transceiver, a power amplification module (PAM), a frequency filter, a low noise amplifier (LNA), or an antenna.

The VR headset 110 may execute or reproduce VR information received from the server 200 to display a 3D terrain and a drone swarm projected onto a VR space by using the display unit 114.

Moreover, the VR headset 110 may display a real terrain image or a real terrain video, which is actually captured. The VR headset 110 may display a virtual drone swarm rendered to the real terrain image or the real terrain video together. The VR headset 110 may simulate a user action on a VR space.

The VR headset 110 may display, on a VR space, a virtual guideline representing a direction indicated by the VR controller 130 and a virtual pointer which is an end point of the virtual guideline. The pointer may move in a 3D terrain on the basis of a motion of the VR controller 130.

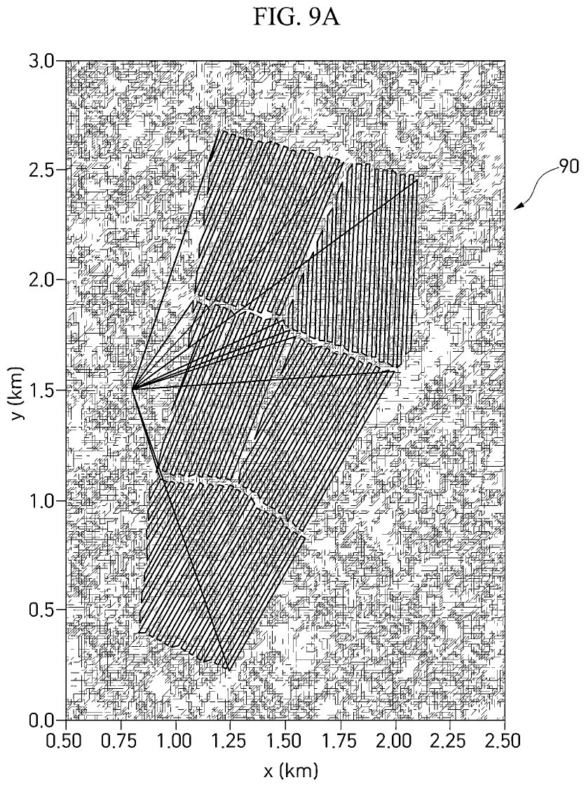

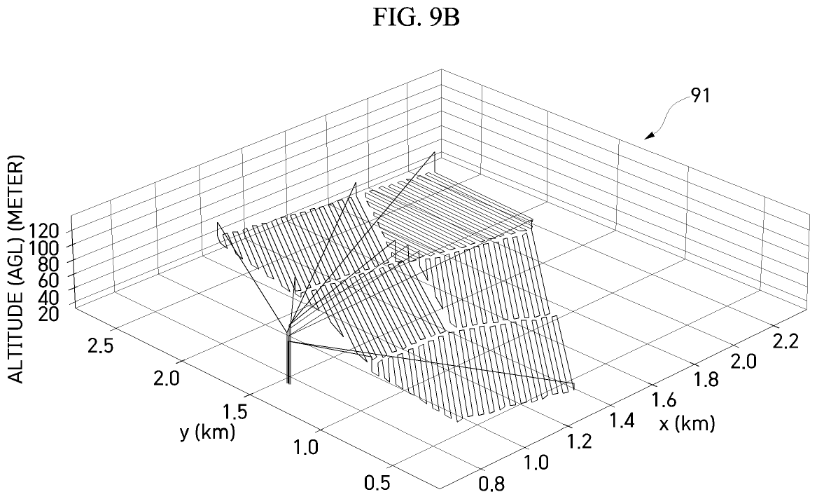

FIGS. 9A and 9B are diagrams for describing a simulation result of a swarm mission planning according to an embodiment of the present invention.

Referring to FIG. 9A, when five drones are respectively allocated to five cells in an ROI divided into the five cells, a user may check a simulation result of a swarm mission planning as illustrated in FIG. 9A.

The simulation result 90 may represent a viewpoint at which a coverage path set in five cells is seen from above and may be transmitted from the server 200 to the VR headset 110, and the VR headset 110 may project the simulation result 90 onto a VR space and may provide the simulation result 90 to a user, whereby the user may visually check whether a swarm mission planning desired by the user is appropriate or not, through the VR headset 110.

Moreover, as illustrated in FIG. 9B, the user may check the simulation result 91 expressed in a 3D coordinate system. The simulation result 91 may represent a mission altitude and a coverage path set in five cells by using a 3D coordinate system, and the user may visually check whether a swarm mission planning, in which a mission altitude desired by the user is reflected, is appropriate or not, through the VR headset 110.

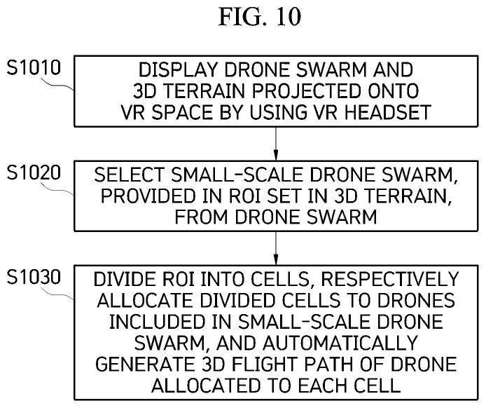

FIG. 10 is a flowchart for describing a method of controlling a drone swarm on the basis of immersive VR, according to an embodiment of the present invention.

Referring to FIG. 10, first, in step S1010, a process of displaying a drone swarm and a 3D terrain projected onto a VR space by using the VR headset 110 of the VR device 100 on the basis of user manipulation may be performed.

Subsequently, in step S1020, a process of selecting a small-scale drone swarm, provided in an ROI set in the 3D terrain, from the drone swarm by using the VR controller 130 on the basis of the user manipulation may be performed.

Subsequently, in step S1030, a process of dividing, by using the server 200, the ROI into a plurality of cells, respectively allocating the divided cells to drones included in the small-scale drone swarm, and automatically generating a 3D flight path of a drone allocated to each of the cells, based on user input information including the ROI and the small-scale drone swarm, may be performed.

In an embodiment, the step S1010 may include a process of setting a polygonal ROI on the basis of the user manipulation which draws a line surrounding the ROI in the 3D terrain by using a virtual guideline representing a direction indicated by the VR controller and a virtual pointer representing an end point of the virtual guideline. Here, the line may be displayed by an outline having a specific fluorescent color.

In an embodiment, the step S1010 may include a process of selecting the small-scale drone swarm including drones which is to be provided to the ROI, based on the user manipulation which draws a line surrounding the drones, which is to be provided to the ROI, of all drones included in the drone swarm by using a virtual guideline representing a direction indicated by the VR controller and a virtual pointer representing an end point of the virtual guideline. Here, the drones included in the small-scale drone swarm may be displayed by an outline having a specific fluorescent color.

In an embodiment, the step S1010 may include a process of dividing the ROI into a number of cells equal to the number of drones included in the small-scale drone swarm, a process of respectively allocating the divided cells to the drones included in the small-scale drone swarm by using a mission assignment algorithm, and a process of automatically generating a 3D flight path of the drone allocated to each cell by using a path planning algorithm.

In an embodiment, the process of dividing the ROI into a number of cells equal to the number of drones included in the small-scale drone swarm may include a process of generating a plurality of random sampling points in the ROI, a process of clustering the random sampling points into a number of clusters equal to the number of drones included in the small-scale drone swarm by using a clustering algorithm, and a process of dividing the ROI into a number of cells equal to the number of drones included in the small-scale drone swarm with respect to a centroid of each cluster on the basis of the Voronoi partition scheme.

In an embodiment, the mission assignment algorithm may be one of the linear sum assignment algorithm, the sequential greedy assignment algorithm, the Hungarian algorithm, and an algorithm implemented by a combination thereof.

In an embodiment, the process of automatically generating the 3D flight path may include a process of, when the ROI is set in a polygonal shape, setting a start point closest to a vertex of an arbitrary line segment selected from among line segments configuring the polygonal shape, a process of setting a scan direction parallel to the arbitrary line segment, a process of setting the number of stripes formed in the scan direction and a distance between adjacent stripes, and a process of generating the 3D flight path including a coverage path formed in a zigzag shape, based on the set number of stripes and the set distance between adjacent stripes.

In an embodiment, the process of automatically generating the 3D flight path may include a process of automatically generating the 3D flight path including a drone-based mission altitude included in the user input information. Here, the drone-based mission altitude may be set through a setting item of a virtual menu window projected onto a VR space by using the VR controller, based on the user manipulation.

According to the embodiments of the present invention, user input information for setting a swarm mission planning may be generated by using a VR device, and thus, a time needed for setting the swarm mission planning by the user may be considerably reduced.

In conventional swarm control, a user may check a mission situation and a state of a current drone swarm through two-dimensional monitoring/display which is limited, but in the embodiments of the present invention, because the mission situation and the state of the current drone swarm are checked by using the VR device, the user may easily and quickly recognize a flight path and a three-dimensional distribution of the drone swarm on the basis of a spatial perspective. Also, the user may quickly recognize a complicated terrain such as a mountainous terrain and an urban environment on the basis of a virtual 3D terrain displayed by the VR device.

Moreover, in the conventional swarm control, a user may set a drone-based mission planning by using a conventional input interface such as a keyboard, a mouse, or a touch screen, but in the embodiments of the present invention, because the drone-based mission planning may be intuitively input by using the VR device, one user may set a mission planning of a drone swarm.

Moreover, in the embodiments of the present invention, a drone-based mission planning may be generated, and a server may automatically process a series of processes of uploading the generated mission planning to each drone.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A drone swarm control method comprising:
displaying a drone swarm and a three-dimensional (3D) terrain projected onto a virtual reality (VR) space by using a VR headset, based on user manipulation;
selecting a small-scale drone swarm, provided in a region of interest (ROI) set in the 3D terrain, from the drone swarm by using a VR controller, based on the user manipulation; and
dividing, by using a server, the ROI into a plurality of cells, respectively allocating the divided plurality of cells to drones included in the small-scale drone swarm, and automatically generating a 3D flight path of a drone allocated to each of the divided plurality of cells, based on user input information representing the small-scale drone swarm and the ROI.

2. The drone swarm control method of claim 1, wherein the selecting comprises setting a polygonal ROI, based on the user manipulation which draws a line surrounding the ROI in the 3D terrain by using a virtual guideline representing a direction indicated by the VR controller and a virtual pointer representing an end point of the virtual guideline.

3. The drone swarm control method of claim 2, wherein the line is displayed by an outline having a specific fluorescent color.

4. The drone swarm control method of claim 1, wherein the selecting comprises selecting the small-scale drone swarm including drones which is to be provided to the ROI, based on the user manipulation which draws a line surrounding drones, which is to be provided to the ROI, of all drones included in the drone swarm by using a virtual guideline representing a direction indicated by the VR controller and a virtual pointer representing an end point of the virtual guideline.

5. The drone swarm control method of claim 4, wherein the drones included in the small-scale drone swarm are displayed by an outline having a specific fluorescent color.

6. The drone swarm control method of claim 1, wherein the generating comprises:
dividing the ROI into a number of cells equal to the number of drones included in the small-scale drone swarm;
respectively allocating the divided cells to the drones included in the small-scale drone swarm by using a mission assignment algorithm; and
automatically generating a 3D flight path of a corresponding drone allocated to each cell by using a path planning algorithm.

7. The drone swarm control method of claim 6, wherein the dividing the of ROI into the cells comprises:
generating a plurality of random sampling points in the ROI;
clustering the plurality of random sampling points into a number of clusters equal to the number of drones included in the small-scale drone swarm by using a clustering algorithm; and
dividing the ROI into a number of cells equal to the number of drones included in the small-scale drone swarm with respect to a centroid of each cluster, based on a Voronoi partition scheme.

8. The drone swarm control method of claim 6, wherein the mission assignment algorithm is one of a linear sum assignment algorithm, a sequential greedy assignment algorithm, a Hungarian algorithm, and an algorithm implemented by a combination thereof.

9. The drone swarm control method of claim 6, wherein the automatically generating of the 3D flight path comprises:
when the ROI is set in a polygonal shape, setting a start point closest to a vertex of an arbitrary line segment selected from among line segments configuring the polygonal shape;
setting a scan direction parallel to the arbitrary line segment;
setting the number of stripes formed in the scan direction and a distance between adjacent stripes; and
generating the 3D flight path including a coverage path generated in a zigzag shape, based on the set number of stripes and the set distance between adjacent stripes.

10. The drone swarm control method of claim 6, wherein the automatically generating of the 3D flight path comprises automatically generating the 3D flight path including a drone-based mission altitude included in the user input information.

11. The drone swarm control method of claim 10, wherein the drone-based mission altitude is set through a setting item of a virtual menu window projected onto a VR space by using the VR controller, based on the user manipulation.

12. A virtual reality (VR) device comprising:
a VR headset configured to display a drone swarm and a three-dimensional (3D) terrain projected onto a VR space, based on user manipulation; and
a VR controller configured to set a region of interest (ROI) in the 3D terrain and select a small-scale drone swarm, provided in the set ROI, from the drone swarm, based on the user manipulation,
wherein the VR controller generates user input information including the set ROI and the selected small-scale drone swarm and transmits the user input information to a server which automatically generates a mission planning of the small-scale drone swarm.

13. The VR device of claim 12, wherein the VR headset comprises:
a communication interface configured to receive VR information from the server;
a processor configured to process the VR information; and
a display unit configured to display a VR space included in the VR information and the 3D terrain and the drone swarm projected onto the VR space, based on control by the processor.

14. The VR device of claim 13, wherein the display unit displays a line surrounding the ROI set by the VR controller and the drones included in the small-scale drone swarm provided in the ROI by using outlines having different specific fluorescent colors.

15. The VR device of claim 13, wherein the VR controller comprises:
a sensor configured to sense a motion of the VR controller;
a processor configured to set an ROI in the 3D terrain by using a virtual guideline and a virtual pointer which move in the VR space, based on the motion of the VR controller, select a small-scale drone swarm provided in the set ROI, and generate user input information including the set ROI and the selected small-scale drone swarm; and
a communication interface configured to transmit the user input information to the server.

16. A server comprising:
a first communication interface configured to receive a region of interest (ROI), set in a three-dimensional (3D) terrain projected onto a virtual reality (VR) space by a VR device, and user input information including a small-scale drone swarm provided in the ROI and a mission altitude of each of drones included in the small-scale drone swarm;
a processor configured to divide the ROI into a plurality of cells, respectively allocate the divided plurality of cells to the drones included in the small-scale drone swarm, and automatically calculate a 3D flight path including the mission altitude and a coverage path of a corresponding drone allocated to each of the divided plurality of cells; and
a second communication interface configured to transmit mission planning information including the 3D flight path to the drones included in the small-scale drone swarm.

17. The server of claim 16, wherein the processor performs an operation of dividing the ROI into a number of cells equal to the number of drones included in the small-scale drone swarm.

18. The server of claim 16, wherein the processor performs an operation of respectively allocating the divided cells to the drones included in the small-scale drone swarm by using a mission assignment algorithm.

19. The server of claim 16, wherein the processor automatically calculates a 3D flight path of a corresponding drone allocated to each cell by using a path planning algorithm.
